(19) United States
(12) Patent Application Publication
(10) Pub. No.: US 2007/0142010 A1
(43) Pub. Date: Jun. 21, 2007

(54) Adaptive modulator and method of operating same

(76) Inventor: Gary L. Christopher, Fox River Grove, IL (US)

Correspondence Address: MOTOROLA, INC., 1303 EAST ALGONQUIN ROAD, IL01/3RD, SCHAUMBURG, IL, 60196, US

(21) Appl. No.: 11/312,217

(22) Filed: Dec. 19, 2005

(51) Int. Cl. H04B 1/18

(52) U.S. Cl. 455/161.1

(57) ABSTRACT

Disclosed herein is a modulator module that uses a radio receiver to search the broadcast band for an unoccupied area (ie., unutilized spectrum) where a modulator can transmit without interference. Additionally, it automatically adjusts the modulator and car radio to the same frequency within one of the unoccupied areas to exploit the free spectrum. The system further provides a hands-free approach to using a modulator in a vehicle by automatically adjusting both the modulator and car radio to the same frequency without manual intervention from the user.

### FIELD OF THE INVENTION

The present invention relates to automotive electronics systems. More particularly, the invention relates to an adaptive modulator for providing an audio output signal to a car radio over a frequency unused by broadcast radio.

### BACKGROUND OF THE INVENTION

For many years, automobiles have come from the factory equipped with a variety of audio systems. At first, the audio systems were simple amplitude modulation (AM) radio receivers. With the proliferation of frequency modulated (FM) broadcast radio, FM radios also became common fixtures in vehicles. Today, it is not uncommon for a car radio to include a cassette player, a compact disc (CD) player, a CD changer, etc. Drivers, however, often have other devices that supply some form of audio output, e.g., a digital audio player (MP3 player), a cellular telephone, or a navigation system that provides audible prompts. It is desirable to use the speakers of the car audio system for communicating the audio output of these devices to the driver. Unfortunately, automobile audio systems often do not come equipped with auxiliary input jacks that allow these devices to be connected to the audio system.

In such cases, a FM modulator may be used to transmit audio to the FM radio that is now ubiquitous in automotive audio systems. Although FM modulators are typically used, there is no reason why AM modulators could not also be used, but these devices are much less common. Such devices are well known in the art, and have been used for a number of years, for example, to provide CD player audio to vehicle audio systems not originally equipped for a CD player.

There are three principal drawbacks to these devices. First, a modulator must be manually set to transmit on a frequency that is not occupied by a local broadcast radio station to avoid interference. Second, the radio used to receive the modulator's signal must be manually set to the same frequency that the modulator is transmitting on. Third, an adjustment to the modulator frequency (and receiving radio frequency) will likely be necessary if the vehicle is traveling any significant distance because broadcast radio stations along the route will likely be broadcasting on or near the modulator frequency. This results in undesirable interference, and often the broadcast signal totally overpowers the modulator signal.

This constant need for manual adjustment and readjustment results in user disappointment with the modulator as an interface device, and also presents a distraction to the driver, who often performs the required adjustments while operating the vehicle. Disclosed herein is a system that attempts to minimize the above-mentioned drawbacks and solves or at least minimizes these problems of the prior art.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 illustrates a first configuration of an adaptive modulator in accordance with the present invention;

FIG. 2 illustrates a second configuration of the adaptive modulator in accordance with the present invention;

FIG. 3 illustrates a third configuration of the adaptive modulator in accordance with the present invention; and

FIG. 4 illustrates a flow diagram depicting the operation of a modulator in accordance with the present invention.

### DETAILED DESCRIPTION

The present invention discloses a modulator module that uses a radio receiver to search the relevant broadcast band for an unoccupied area between broadcast stations (i.e., unutilized spectrum) where the modulator can transmit without an interfering broadcast station. The modulator module automatically adjusts its transmit frequency and the car (vehicle) radio's receive frequency to a common frequency within one of the identified areas of unutilized spectrum. Communication with the car radio is preferably over a standard vehicle bus, many variations of which are known to those skilled in the art. This modulator module provides a hands-free approach to using a modulator in a vehicle by eliminating the need for manual user intervention while the vehicle is moving.

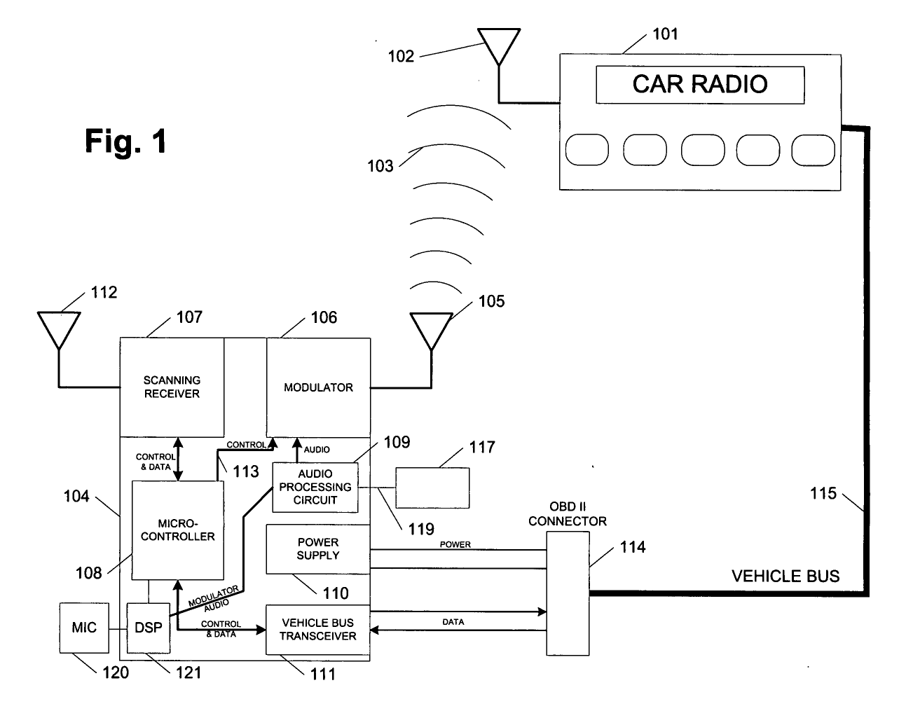

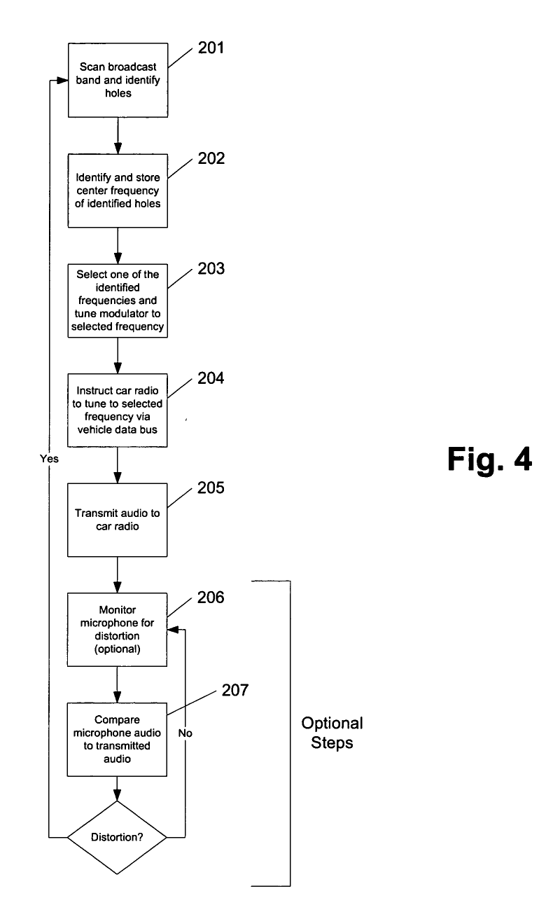

Details of a modulator module in accordance with the present invention may be understood by reference to FIG. 1, while operation of the module may be best understood with reference to the flow diagram of FIG. 4. A car radio 101 receives radio signals 103 via an antenna 102. The radio signals 103 are transmitted from the modulator module 104 through a transmit antenna 105. The modulator module 104 comprises a plurality of functional modules, including a modulator 106, a scanning FM receiver 107, a microcontroller 108, an audio processing circuit 109, a power supply 110, and a vehicle bus transceiver 111. As regards to electrical power, the power supply 110 may derive power from the vehicle's On-Board Diagnostics II (OBD II) connector 114 or any other convenient source of power within the vehicle. Various other modules could also be included in the modulator module 104 without departing from the scope of the present invention.

The audio processing circuit 109 receives an audio connection 119 from an auxiliary device 117, which may be, for example, a navigation system having an audio output, a hands-free mobile telephone kit, a digital audio player, etc. The audio processing circuit 109 may be analog in nature if the auxiliary device 117 outputs analog audio and the modulator 106 only accepts analog audio. Alternatively, the audio processing circuit 109 may be a combination of analog and digital circuitry. If the auxiliary device 117 outputs digital audio, the audio processing circuit 109 may convert it into analog form before passing it to the modulator 106. Typically, modulators accept analog audio. Conversely, the audio processing circuit 109 may take analog audio from the auxiliary device 117 and convert it into digital form before passing it to the modulator 106, if the modulator 106 only accepts digital audio. Thus, the audio processing circuit can take many different forms, as one skilled in the art will understand, such as coder/decoder (codec) circuits, gain amplifiers, analog or digital filters, digital-to-analog converters (DACs) or analog-to-digital converters (ADCs), DSPs, etc.

The audio processing circuit 109 transmits analog audio to the modulator 106, where the analog audio signal modulates a carrier wave generated by the modulator 106. This modulated carrier wave 103 is broadcast through the antenna 105 to the car radio 101 via its own antenna 102. This basic form of modulation is common to modulator devices presently known in the art, and thus details are not discussed here.

To address the first problem of modulator use described above, i.e., frequency selection, the modulator module 104 scans a particular broadcast band to identify holes, i.e., gaps between broadcast stations. This corresponds to step 201 in FIG. 4. These holes, also known as unutilized spectrum, are used by the modulator for transmitting audio to the car radio 101 as described above. As can be seen from FIG. 1, the scanning receiver 107 is independent of the car radio receiver 101. The scanning receiver 107 is controlled by the microcontroller 108, and the scanning receiver returns the identified holes in the broadcast band to the microcontroller 108 for storage in memory (not shown).

The identified holes in the selected broadcast band are thus mapped, and the center frequency of each hole is identified and stored as a candidate for use by the microcontroller 108 (FIG. 4; step 202). When the modulator is called upon to deliver audio to the car radio 101, such as audible directions from a navigation system, an incoming hands free mobile telephone call, or audio file playback from a digital music player, the microcontroller 108 sends one of the stored hole center frequencies to the modulator 106 over a control bus 113 (FIG. 4; step 203). The modulator 106 uses this frequency as a carrier, which is then modulated by the analog audio received from the audio processing circuit 109 to produce the modulated carrier wave 103. In short, the modulator module 104 transmits on the selected frequency.

The particular frequency selected from the identified candidates may be selected by the microcontroller 108 in a variety of ways. For example, the microcontroller 108 may select the frequency corresponding to the widest gap between broadcast stations. Alternatively, the microcontroller 108 may be programmed to receive signal strength information from the scanning receiver 107 and to select a frequency corresponding to a gap having relatively weak broadcast stations adjacent to the gap so as to minimize interference. Other potential selection criteria may also occur to those skilled in the art, and it is intended that the present invention encompass all such alternatives.

In order for the car radio 101 to receive the signal 103 transmitted by the modulator module 104, the car radio 101 must be tuned to the same frequency that the modulator 106 is using, i.e., the frequency selected by the microcontroller 108. It is therefore necessary for the frequency used by the modulator module 104 to be communicated to the car radio 101 (FIG. 4; step 204). Modem automobiles are typically equipped with a vehicle bus 115, which serves as an in-car network to allow various electronic and computerized systems in the vehicle to communicate with each other. If the modulator module 104 has access to the vehicle bus 115, it can communicate with the car radio 101 and instruct the car radio 101 to tune to the selected frequency.

One possible vehicle bus access point is the OBD II connector 114, which is available in all vehicles manufactured since 1996. Another possible vehicle bus access point, available mainly in older vehicles, is a CD changer interface connector. Such connectors are usually located in the vehicle's trunk. In the present example, the OBD II connector 114 is used.

Specifically, the modulator module 104 comprises a vehicle bus transceiver 111 that interfaces with the vehicle through the OBD II connector 114. The vehicle bus transceiver 111 receives control and data information from the microcontroller 108 and processes this information for transmission across the vehicle bus. The microcontroller 108 is thus able to instruct the car radio 101 to tune to the selected frequency used by the modulator 106 by passing an instruction through the vehicle bus transceiver 111 across the vehicle bus 115.

The precise format and nature of the instructions transmitted across the vehicle bus 114 varies depending on the exact in-car network being used, although these functions can be performed on a variety of original equipment manufacturer (OEM) radios using known protocols. For example, General Motors car radios use one of two protocols, known as Class 2 or GMLAN; BMW car radios use a protocol known as I-bus; Ford car radios use a protocol known as Standard Corporate Protocol (SCP), that is an adaptation of J1850; and DaimlerChrysler automobile radios use one of two protocols, either Society of Automotive Engineers (SAE) J1850 or the Controller Area Network (CAN) ISO 11898/11519. One skilled in the art would be familiar with these protocols and thus the details of message formatting and structure are not repeated here.

With both the modulator 106 and the car radio 101 set to the selected frequency, non-radio audio may be delivered through the vehicle's audio system without user intervention. For example, as the vehicle is in motion, the modulator module 104 periodically and/or continuously scans the broadcast band to identify new holes and candidate frequencies so that if interference occurs on a given frequency, e.g., because the vehicle is approaching the vicinity of a broadcast radio station using the current frequency, the modulator module 104 can reset to another empty frequency. The modulator module 104 adapts to this change in conditions (e.g., the interference) by commanding the modulator 106 and the car radio 101 to use a new selected frequency.

The modulator module 104 may optionally be provided with a feedback system for determining whether interference exists on a particular frequency. In one embodiment, such a system could comprise a microphone 120 allowing the modulator module 104 to sample the audio being played back by the car radio 101 (FIG. 4; step 206). This sampled audio may then be compared to the audio signal being transmitted by the modulator module 104 (FIG. 4; step 207), allowing a suitably programmed digital signal processor (DSP) 121 to detect degradation of the audio and trigger the selection of a new frequency (FIG. 4; return to step 201). One skilled in the art will appreciate that some sort of ADC and/or codec (not shown) is required to put the audio from the microphone 120 into a format that can be processed by the DSP 121.

Yet another refinement to the modulator module 104 is to optimize signal strength between the car radio 101 and the modulator 106 by having the modulator module 104 query the car radio 101 for a received signal strength. The modulator module 104 could then adjust its transmit power to optimize the power received by the car radio 101. Exact details of such an arrangement varies depending on the particular implementation and protocol used, but, in general, this is accomplished by communication across the vehicle bus 115. Specifically, the microcontroller 108 sends a message across the vehicle bus 115 requesting the car radio 101 to transmit back its received signal strength. The car radio 101 responds by indicating the strength of the received signal 103. In response to this information, the microcontroller 108 adjusts the transmit power of the modulator 106 accordingly. This adjustment takes place via the control bus 113.

Still another refinement to the modulator module 104 is to have the scanning receiver 107 skip the current selected frequency used by the modulator 106 so that a hole in the spectrum is not erroneously considered to be a frequency occupied by a broadcast radio station. Alternatively, the scanning receiver 107 continues to monitor the currently selected frequency by momentarily disabling the modulator 106 during pauses in the auxiliary audio. This process is coordinated by the microcontroller 108, which simultaneously monitors the audio signal, e.g., by connection to the audio processing circuit 109, and the scanning process of the scanning receiver 107. When there is a break in the audio, e.g., between songs, the controller 108 simultaneously disables the modulator 106 and causes the scanning receiver 107 to scan the portion of the broadcast band in the vicinity of the selected frequency. Disabling of the modulator 106 is accomplished by transmitting the appropriate signals over the control bus 113. Similarly, control of the scanning receiver 107 is accomplished by transmitting the appropriate control and data signals between the microcontroller 108 and the scanning receiver 107.

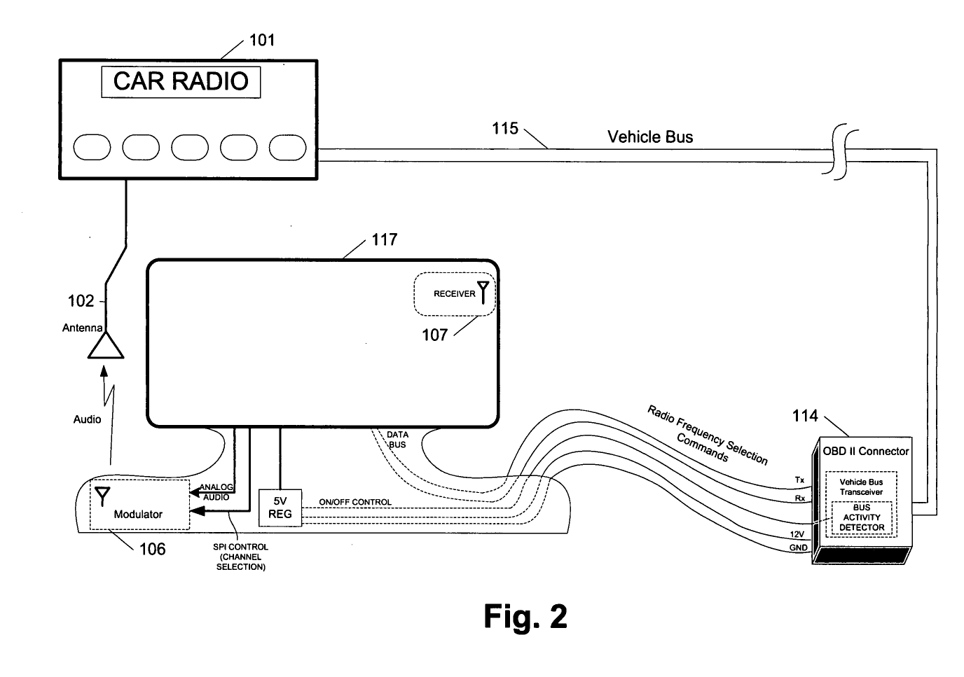

An alternative embodiment of a modulator device in accordance with the teachings of the present invention is illustrated in FIG. 2. In this embodiment, an auxiliary audio device 117 incorporates the scanning receiver 107 and the modulator 106. The auxiliary audio device 117 also directly interfaces with the OBD II connector 114. Because the scanning receiver 107, the modulator 106, and the vehicle bus interface are integrated with the auxiliary audio device 117, the auxiliary audio device 117 is able to transmit audio information directly without requiring a separate modulator module.

In this embodiment, the desired frequency is selected in the same manner as the system described with respect to FIG. 1. Specifically, a microcontroller (not shown) incorporated within the auxiliary audio device 117 causes the scanning receiver 107, which is also part of the auxiliary audio device 117, to scan for holes in the appropriate broadcast band. The microcontroller (not shown) then selects the center frequency of one of the identified holes for transmission. The microcontroller (not shown) then causes the modulator 106 to tune to the selected frequency so that audio may be broadcast to the car radio 101. Simultaneously, the microcontroller (not shown) transmits a radio channel selection command over the vehicle bus 115 to the car radio 101. As in the embodiment of FIG. 1, the radio frequency selection command is transmitted to the car radio 101 via the vehicle bus 115. The auxiliary audio device 117 interfaces with the vehicle bus 115 using the OBD II connector 114.

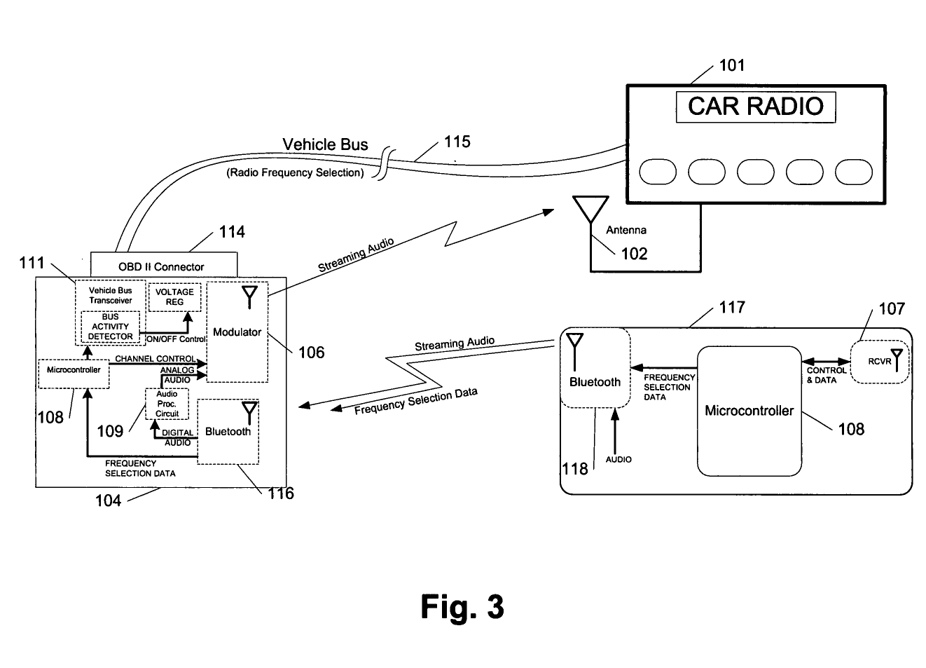

Another alternative embodiment is illustrated in FIG. 3. In this embodiment, the auxiliary audio device 117 comprises the scanning receiver 107, like the embodiment of FIG. 2. The auxiliary audio device 117, however, also comprises a Bluetooth interface 118. The modulator module 104 also includes a Bluetooth interface 116, which allows the modulator module 104 to receive both audio and control data (i.e., frequency selection commands) transmitted from the auxiliary audio device 117. Although Bluetooth is used in this embodiment, any variety of wireless networking protocol could be used.

Specifically, a microcontroller (not shown) in the auxiliary audio device 117 operates the scanning receiver 107 to identify holes in the desired broadcast band and select the center frequency of one of these holes in a manner substantially identical to that described above. The microcontroller (not shown) then passes the selected frequency along with a channel selection command to the modulator module 104 using the Bluetooth interface 118. Additionally, the audio information to be transmitted may also be transmitted to the modulator module 104 using the Bluetooth interface 118.

At the modulator module 104, the Bluetooth interface 116 receives the channel selection command and audio information from the auxiliary audio device 117. The Bluetooth interface 116 passes the channel control data to two other modules within the modulator module 114, namely, the vehicle bus transceiver 111 and the modulator 106. The modulator 106 uses this channel selection command to tune itself to the selected frequency for transmission. The vehicle bus transceiver 111 uses this data to generate a command for the car radio 101 to tune to the selected frequency in accordance with the particular communication protocol in use. As in the previous embodiments, the vehicle bus transceiver 111 interfaces with the vehicle bus 115 using the OBD II connector 114.

The Bluetooth module 116 also receives the audio data from the auxiliary audio device 117 in the form of streaming audio. This streaming audio is passed in digital form to the audio processing circuit 109, which converts it into an analog audio signal suitable for modulating the carrier wave generated by the modulator 106. The modulated carrier wave is then transmitted where it is picked up by the car radio 101 using the antenna 102. In all other respects, operation of the system shown in FIG. 3 is substantially similar to the other embodiments.

It should be understood that the inventive concepts disclosed herein are capable of many modifications, combinations and sub-combinations. For example, either AM or FM modulation could be used. Additionally, various arrangements of the described modules within individual devices are also possible. As illustrated by the alternative arrangements of FIGS. 1-3, the functionality of the system does not necessarily require that particular modules be incorporated within particular devices. To the extent such permutations fall within the scope of the appended claims and their equivalents, they are intended to be covered by this patent.

What is claimed is:

1. A modulator module comprising:
a scanning radio receiver;
a microcontroller, coupled to the scanning radio receiver, and configured to cause the scanning radio receiver to identify one or more holes in a broadcast band and further configured to determine a center frequency for each of the identified holes;
a modulator, coupled to the microcontroller, configured to transmit an audio signal on a selected frequency provided by the microcontroller, wherein the selected frequency is the center frequency of one of the identified holes; and
an audio input for coupling an audio signal to be transmitted by the modulator.

2. The modulator module of claim 1 further comprising a transceiver, coupled to the microcontroller, for communicating the selected frequency to a car radio and instructing the car radio to tune to the selected frequency.

3. The modulator module of claim 2 wherein the transceiver communicates with a car radio over a vehicle bus.

4. The modulator module of claim 3 wherein the transceiver interfaces with the vehicle bus via an on-board diagnostics (OBD) connector.

5. The modulator module of claim 2 wherein the modulator module is configured to query the automobile radio to determine a received signal strength and adjust a transmitted power of the modulator accordingly.

6. The modulator module of claim 1 further comprising:
a microphone configured to sample the audio played by a radio receiving a signal supplied by the modulator; and
a digital signal processor, coupled to the microphone and the microcontroller, the digital signal processor programmed to compare the sampled audio to the audio signal supplied to the modulator to detect distortion caused by interference on the selected frequency.

7. A method of adaptively configuring a radio modulator, the method comprising:
scanning a frequency band to identify one or more holes in the frequency band;
identifying a center frequency of each identified hole in the frequency band;
selecting one of the identified center frequencies;
setting a radio modulator to transmit on the selected frequency; and
instructing a receiving radio to tune to the selected frequency.

8. The method of claim 7 wherein the steps are repeated periodically.

9. The method of claim 7 wherein transmitting the selected frequency to the receiving radio is performed over a vehicle bus.

10. The method of claim 9 wherein the interface to the vehicle bus is an on-board diagnostics (OBD) connector.

11. The method of claim 7 further comprising:
sampling audio played back by the receiving radio; and
comparing the played back audio to the transmitted audio to detect interference.

12. The method of claim 7 further comprising:
querying the receiving radio to determine a received signal strength; and
adjusting the power of a transmitter to optimize the received signal strength.

13. A radio modulator module comprising:
a wireless network receiver configured to receive audio from an auxiliary audio device; and
a modulator configured to receive the audio and transmit the audio to a receiving radio device,
wherein the modulator is set to a frequency selected by the auxiliary audio device, the frequency being received via the wireless network receiver.

14. The radio modulator module of claim 13 further comprising a vehicle bus transceiver for communicating the selected frequency to the receiving radio device over a vehicle bus.

15. The radio modulator module of claim 14 wherein the vehicle bus transceiver interfaces with the vehicle bus through an on-board diagnostics (OBD) connector.

16. The radio modulator module of claim 13 wherein the wireless network receiver is a Bluetooth network receiver.

17. The radio modulator of claim 13 wherein the auxiliary audio device comprises:
a scanning radio receiver configured to scan a broadcast band, identify one or more holes in the broadcast band, determine a center frequency of the one or more holes, and set the radio modulator to transmit on one of the center frequencies; and
a controller configured to instruct the receiving radio device to tune to the transmit frequency.

18. The radio modulator of claim 17 further comprising: a microphone configured to sample the audio when played by the receiving radio device; and
a digital signal processor configured to receive the sampled audio and programmed to compare the sampled audio to the transmitted audio and detect distortion caused by interference on the transmit frequency.
